(19) United States
(12) Patent Application Publication
(10) Pub. No.: US 2014/0233754 A1
(43) Pub. Date: Aug. 21, 2014

(54) HEADPHONE SYSTEM WITH RETRACTABLE MICROPHONE

(71) Applicant: Polk Audio, Inc., Baltimore, MD (US)

(72) Inventors: Kenneth S. Chae, Baltimore, MD (US); Michael DiTullo, Encinitas, CA (US); Camaron Nielson, Oceanside, CA (US)

(73) Assignee: Polk Audio, Inc., Baltimore, MD (US)

(21) Appl. No.: 14/182,738

(22) Filed: Feb. 18, 2014

Related U.S. Application Data
(60) Provisional application No. 61/765,893, filed on Feb. 18, 2013.

(51) Int. Cl. H04R 1/10; H04R 1/08

(52) U.S. Cl. CPC H04R 1/1091; H04R 1/08; H04R 1/1041
USPC 381/74

(57) ABSTRACT

A retractable gaming headphone communication system without a retractable microphone boom retracted in a simple one touch fashion. The headphone communication system is automatically disengaged and put in an off or mute mode when boom is in a deployed position and an operational communication mode when in a deployed position. the system provides an interface for digital bidirectional communication with other users. The system further provide for kinetic integration in the gaming environment.

### CROSS-REFERENCE TO RELATED APPLICATIONS

This application claims the benefit of U.S. Provisional Patent Application Ser. No. 61/765,893 filed February 18, 2013 entitled HEADPHONE SYSTEM WITH RETRACTABLE MICROPHONE.

### BACKGROUND AND SUMMARY OF THE INVENTION

1. Field of Invention

The present invention is in the field of audio headphones, and more particularly headphones having a microphone that may be retracted to a secure position when not in use and to a deployed position when in use enabling a communication system.

2. Summary of the Art

Audio headphones have long been a staple for audiophiles and for use in applications where the quality of the audio experience of the listener was crucial. With active lifestyles and the introduction of the digital audio players and smart phones, the use of audio headphones has continued to grow significantly. Multi-player and on-line interactive video gaming has also become popular, creating demand for specialized headphones that are designed to reproduce more authentic emersion of players into the game. Gamers use headphones to enhance the gamers over all gaming experience by providing the sensation of directionality of sound that represents object and players in the gaming environment, and that provide capabilities for communication with other players.

Audio headphones generally include an ear piece or cup for each ear that houses the audio speaker driver. The ear piece of headphones can be over the ear with an enclosure that covers the entire ear and minimizes or prevents outside noise from entering the ear. The ear piece can also be an on-ear type without the ear enclosure or in-ear buds. The on-ear and over-the-ear ear piece is generally attached to a head band that can be adjusted to fit the head of the individual listener.

The ear piece contains an audio transducer. The transducer receives audio signals from an audio source player. The source player transmits the signal to the headphones through an audio cord that is preferably shielded to prevent electrical interference and usually covered with a thin plastic or rubberized material that is flexible, the cord having an electrical connector or jack at the terminal end for making electrical connection with the source player. One limitation with the cord is that it must be of a sufficient length to allow the headphones to reach the listeners ears while maintaining the source at a stable location such as in the user's pocket or clipped to the user's belt. Headphones have been developed to provide the audio signal wirelessly . Currently, very popular wireless headphones include infrared earphones, radio frequency (RF) earphones, and Bluetooth earphones. Bluetooth technology's unique and miniaturized design is important for wireless bidirectional digital transfer of digital information and increased data transfer capabilities important for gaming.

For interactive gaming and other applications, headphones include a microphone to allow communication between players. These designs generally require a boom for the microphone to be positioned in front of the user's mouth in order to obtain the proper audio quality. A boom configuration is undesirable for most gamers because the player may accidentally touch the boom while speaking or the boom can be an obstruction while the gamer is consuming food or beverage during play. Additionally, gaming headphones may not be appropriate or convenient for use in environments at a distance away from the computer, therefore limiting their application. When in public, while listening to music, the boom may be unnecessary and obstructive with the microphone protrude from the headphone. Dealing with the microphone becomes very inconvenient and annoying. Some manufactures have addressed this limitation by developing a telescopic boom for the microphone. Although, this design provides some improvement, it is still limited in that the boom remains attached to the head band or ear piece and continues to interfere with the gaming experience. The user must pull the telescope sections out and lock them in place. This makes retraction difficult and inconvenient, often requiring the gamer to remove the headphone to retract the microphone.

### SUMMARY OF THE INVENTION

The current invention overcomes the limitation of the prior art. It is one object of the invention to have a headphone system with a retractable microphone to overcome the drawbacks that exist in earphones having microphones.

It is an object of the invention to proved a retractable microphone system without a boom, but that retract is a simple one touch fashion.

It is an object of the invention to provide a gaming headphone with a retractable microphone wherein when retracted the headphone communication system is automatically disengaged and put in an off mode or alternatively a mute mode.

It is an object of the invention to provide a gaming headphone with a retractable microphone wherein when the microphone is in a deployed position the communications system is engaged and put in the operation mode.

It is a further objective of the present invention to provide a headphone system with an interface that provides a means for digital bidirectional communication with other users.

### BRIEF DESCRIPTION OF THE DRAWING

The features and advantages of the present invention and the structure and the technical means adopted by the present invention to achieve the above and other objects can be best understood by referring to the accompanied drawings.

FIG. 1A is an perspective view of the inventive headphones with retractable microphone according to one embodiment of the present invention, wherein the retractable microphone is in an deployed position for use.

FIG. 1B is a perspective view of the inventive headphones with retractable microphone according to one embodiment of the present invention, wherein the retractable microphone is in a retracted position.

FIG. 2 is an exploded view of the mechanical construction of only one representative ear piece of the inventive headphones with retractable microphone according to one embodiment of the present invention.

FIG. 3 Is a block diagram of the inventive headphone system with retractable microphone according to one embodiment of the present invention.

FIG. 4 is an exploded schematic view the mechanical construction of only one representative ear piece of the inventive headphones with retractable microphone according to one embodiment of the present invention.

FIG. 5A is a perspective drawing of the gaming controller with transceiver uncoupled according to one embodiment of the present invention.

FIG. 5B is a perspective drawing of the gaming controller with transceiver coupled according to one embodiment of the present invention.

### DESCRIPTION OF THE INVENTION

The disclosed embodiment of the current invention relates to an audio gaming headphone system with a retractable microphone system. The objects of this invention is to provide novel solutions to overcome the limitation described relating to current audio gaming headphone systems having retractable microphone booms.

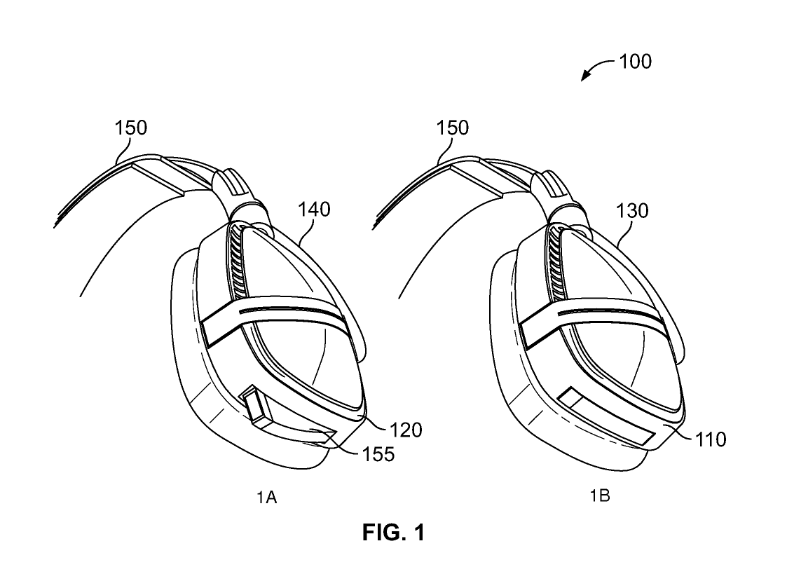

Now with reference to the figures, FIGS. 1-3, disclosed is one embodiment of the present inventive headphone system 100. The inventive headphone system 100 is comprised of a first ear piece 110 and a second ear piece 120 for fitting to each ear and providing sound to the listener. Each ear piece 110, 120 is secured by attachment to a swivel connector 130, 140, which are secured to a head band 150. For better illustration of each ear piece, FIG. 1A and 1B show the headband 150 in partial view, however the headband 150 is a single band. In one ear piece 120, incorporated is a microphone boom 155, which can be in a deployed position as show, or in a retracted position, wherein the boom is concealed within the ear piece 120. When in a retracted position the boom 155 is essentially flush with the surface or the ear piece 120

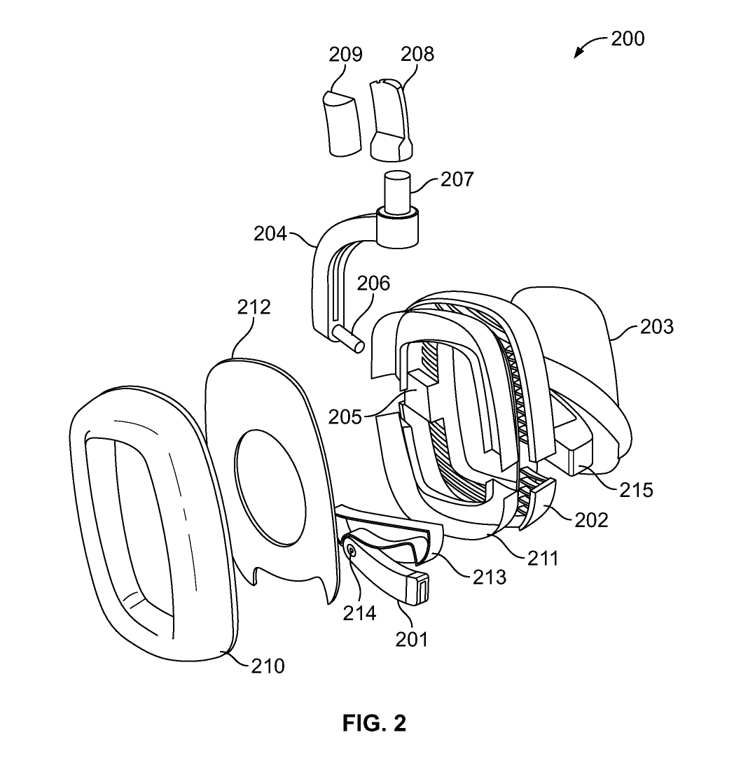

FIG. 2 shows the mechanical construction of only one representative ear piece 200 having the microphone boom 201. The ear piece 200 is comprised of a housing base structure 202, which can be constructed of any rigid or semi-rigid material such as a metal or hard plastic. The housing base structure 201 serves as a mounting structure to secure the various components within the ear piece 200, such as integrated circuits and the audio transducer. The housing base 202 is covered on the outer surface by an outer plate 203 that covers an open cavity (not shown) on the outer portion of the housing plate 203. The outer plate 203 is primarily ornamental and can be constructed of any number of materials and ornamental configurations that suit the desired aesthetics of the headphones.

To secure the housing base 202 to the headphone band, one end of a swivel arm 204 is inserted into the housing connector 205 by a post 206. The housing connector 205 and post 206 can be of any configuration, but preferably, the housing base 202 can rotate about the post 206 on a horizontal plane using a tube connector with a swivel flange. On the other end, the swivel arm 204 is secured to the headband (not shown) on a vertical plain using a post 207 tube connector secured with two halves a swivel flange 208 and 209. In one contemplated embodiment of the invention, the ear piece 200 includes compartment or module 215 for housing one or more servo mechanisms (not shown) that generate motion within the headphones ear piece based on signals received from the gaming console. This motion simulates actions that occur within the game such as turning, shaking, tilting, temperature change or compression.

The ear piece 200 includes an ear cushion 210 which is mounted the housing base 202 with a mounting grommet 211 and plate 212 for securing the audio transducer (not shown). The ear cushion can be secured in a number of well known ways, such as adhesive, threading, or tongue and groove. The speaker boom module mount 213 is secured to the housing base 202 by compression fit with grommet 211 and screws. the microphone boom 201 is secured to the mount 213 by a hinge 214.

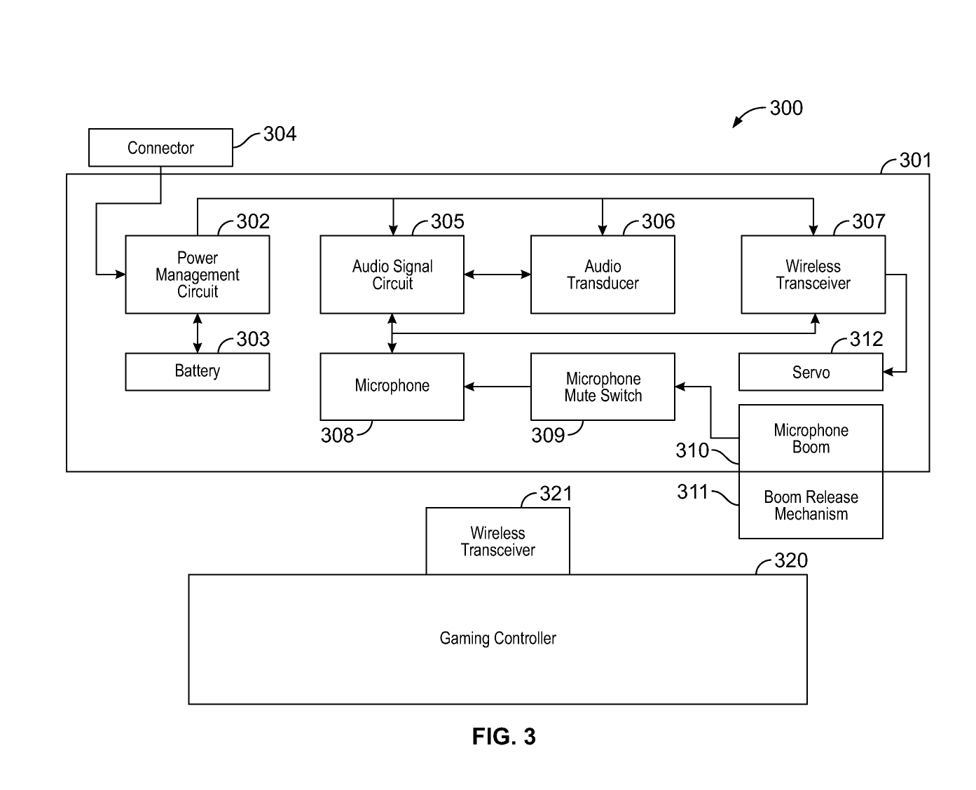

Now with reference to FIG. 3, shown is a block diagram of the headphone system 300. Each ear piece 301 includes a power management circuit 302, which one skilled in the art will appreciate to be any one of a number of well known power management circuits. The power management circuit 302 manages the power distribution and consumption of the system 300, providing power to the components of the ear piece 301. Power is preferably provided by a battery 303, which may be, but is not necessarily rechargeable. Recharging the battery can be accomplished through a charging connector 304, which is part of the power management circuit 302. The charging circuit can be any type of well know charging protocol, such as fast charge, inductive charge, pulsed charge or trickle charge. The preferred charging connector is a USB charging connector. By providing a connector in the ear piece, the listener can hard wire to compatible devices or replace the cord with a wireless adaptor upgrade. In one embodiment, each ear piece may have an electrical connector for accepting a RCA cord jack that provides the audio signal; the cord having a jack for providing power to each headphone and a third jack portion for the audio source.

The ear piece 301 also includes an audio signal circuit module 305. The audio signal circuit 105 intentionally alter auditory output signals or sound outputs to enhance aspects of the audio effect and listening experience of the gamer to create a sense of directionality of sound or the enhancement of particular sounds. This is especially important in the gaming context to provide the gamer a sense of the location or direction of other players or objects in the gaming environment. The audio signals may be electronically represented in either digital or analog format, signal processing may occur in either transmission mode. Analog processors operate directly on the electrical signal, while digital processors operate mathematically on the digital representation of that signal.

The audio signal is transmitted to an audio transducer 306 to convert the signal into acoustic sound waves perceptible to the listener, or the signal may be communicated to a wireless transceiver 307. There are a number of well known arrangements and configurations for headphone transducers. All of these transducer arrangements are contemplated to be within the scope of the current invention.

The audio signal circuitry 305 also provides for accepting communication signals from a microphone 308. The microphone 308 is associated with a microphone switch 309 for muting the input to the microphone 308 and is secured within a microphone boom member 310. The microphone is also in communication with the audio signal processing circuit 305, which receives signals generated by the microphone 308 and provides a output signal. Such output signal may include any well-known analog or digital output. The signal generated by the microphone 308 may be output from the audio signal circuitry 305 through a wireless transceiver 307. However, it will be appreciated by one skilled in the art that the output can be through any wired or wireless channel, including any known signal cable, RF, infrared or Bluetooth.

The wireless transceiver 307 provides for analog or digital audio interfacing with and in communications with other devices, such as a gaming controller 320. The digital interface means may be a standard USB or similar type of serial bus connector, but is preferably by way of short range wireless signal transceiver such as a Bluetooth transceiver 321. The gaming controller 320 is in wireless communication with the gaming console (not shown), and wirelessly communicates audio signal from the gaming console to the headphones through the transceiver bridge between the gaming controller wireless transceiver 321 and the headphone transceiver 307. The audio signal circuit 305 can receive audio signals from the microphone 308 and can format such signals for transmission the wireless transceiver 302 to the gaming controller wireless transceiver 321. This provides for communication from the headphone wearer to other gamers in the gaming environment.

In one contemplated embodiment of the invention, the ear piece 301 includes one or more servo mechanisms 312 that generate motion within the headphones ear piece based on signals received from the gaming console. This motion provides another layer of immersion within the gaming experience by simulating actions that occur within the game such as turning, shaking, tilting, temperature change or compression.

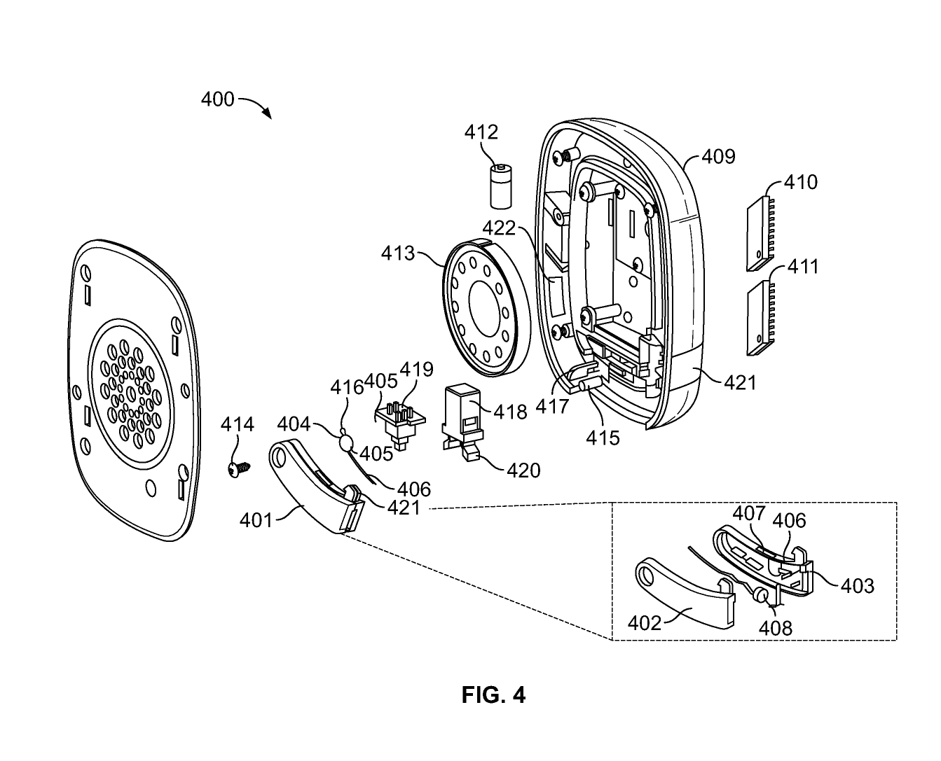

Now with reference to FIG. 4, shown is a more detailed exploded view of a portion of the ear piece 400 and more particularly the microphone boom retraction and release mechanism.

The ear piece 400 includes a housing 409 for securing components of the headphones, including the power management circuit 410 with battery 412, and the audio signal circuit 411 and audio transducer 413. As shown, the power management circuit 410 and audio signal circuit 411 are independent integrated circuits, which are mounted to a printed circuit board within the housing 409.

In the disclosed embodiment, the boom assembly 401 is secured to the ear piece housing 409 with a screw 414 tightened into a screw hole 415, and pivots on the screw 414 between a retracted position and a deployed position. The microphone boom assembly 401 is comprised of two halves of a boom housing 402 and 403. The microphone boom assembly 401 is associated with a tension spring 404 having a compression coil 405 and spring arm 406. The spring 406 arm is secured into one half of the boom housing assembly 403 through a clip mechanism 407. A microphone 408 is also secured within the boom 401 using a clip. The spring coil 405 includes a tension anchor 416 which is secured to the housing 409 at an spring anchor location 417 when the ear piece 400 is fully assembled. When the boom assembly 401 is in the retracted position within the housing 409 the compression coil is tightened causing compression and forcing the boom assembly 401 into a deployed position.

The system also include a boom locking mechanism 415 that restrains the boom assembly 401 within the housing 409 when in the retracted position and allows the boom member 401 to be deployed when the lock mechanism 418 is disengaged. The locking mechanism 418 may be any well-known type of lock such as a push button, push grip, slider tab, turn lock, magnetic lock, push-in/push-out or similar lock. In the disclosed embodiment, secured within the housing 409 is a single point cam lock mechanism 418 and an associated mute switch 419. When retracted in to the body of the housing 409, the lock head 421 of the boom assembly 401 causes the cams 420 of the camlock mechanism 418 to compress around the lock head 421, securing the boom assembly 401 within the housing 409. Associated with the lock mechanism 418 and the microphone 408 is a microphone mute switch 419. The mute switch 419 is engaged and mutes the microphone 408 when the boom assembly 401 is in put in the retracted position and the camlock 418 is engaged. When the boom assembly 401 is in the deployed position, the mute switch 419 is disengaged, the camlock is released and the microphone is operational. The action of muting the microphone when the boom is retracted allows the user to listen to audio without having a conspicuous microphone being visible.

Also secured within the housing is a motion module 421 for sensing or generating motion. The motion module 421 contains one or more motion generating devices, such as servo motors, hammer, unbalanced mass, or other mechanical vibrator. The motion detection can be achieved by both mechanical and electronic methods, such as gyro, optical and acoustical motion detection devices, such as PIR motion detectors. Signals from the motion detectors are communicated to the audio processing circuit for transmission to the gaming consol and in turn reflecting position data or motion data of the headphone system wearer onto a character's position or motion within the gaming environment. I will be appreciated that, when the muting of the microphone occurs, disabling of the motion generating and sensing may also likewise be disabled.

The housing 409 also secures a transceiver module 422 for communication with another device capable of receiving wireless signals. Preferably, the transceiver is a Bluetooth module, but can be any type of well know IR, RF or directly wired link. The microphone 408 audio date is communicated to the audio signal circuit 411 for processing a data packaging and transfer to the wireless transceiver 422.

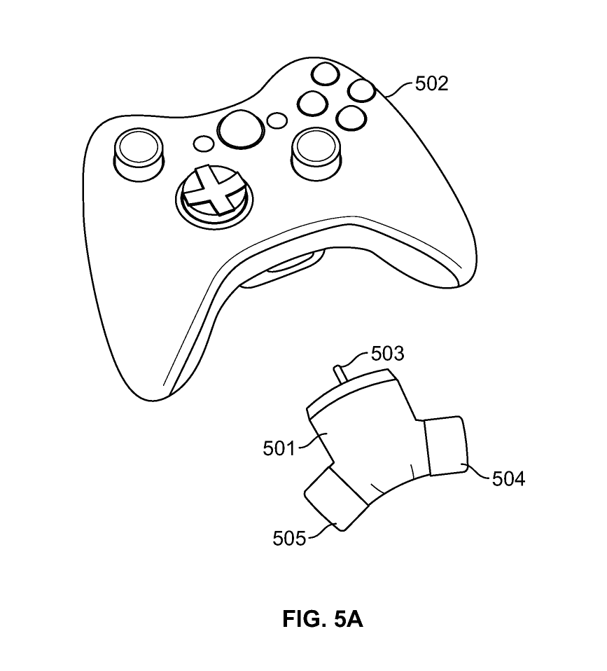

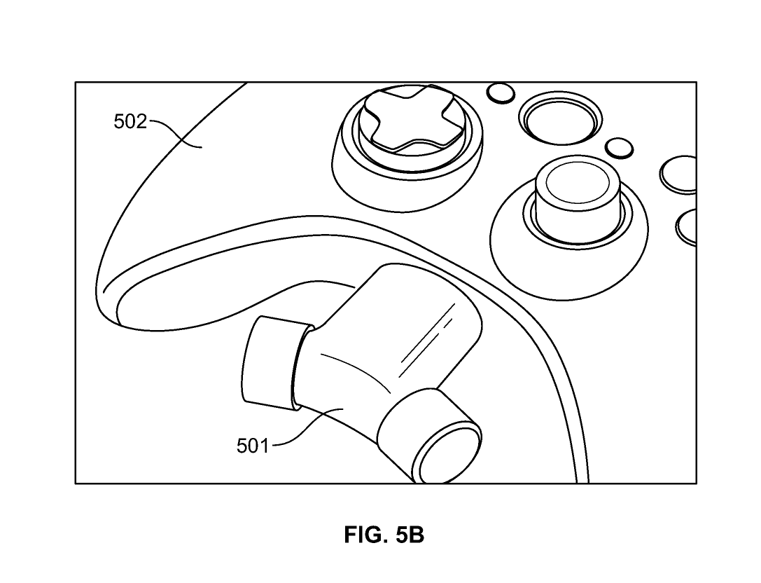

Now referring to FIGS. 5A and 5B, the system may include a transceiver module 501 associated with a gaming controller 502. The transceiver 501 is preferably a Bluetooth receiver module having a connector jack 503 for securing the transceiver 501 to the gaming controller 502 and for providing a communication bridge between the gaming console to the controller to the headphone system. Also incorporated into the transceiver module are various manual controls for volume 504 and balance 505. One of ordinary skill in the art will understand that any control function button or switch can but built into the transceiver and all controls are contemplated within the invention. FIG. 5A shows the transceiver 501 secured to the gaming controller 502. This configuration provides for a free moving gaming experience where both audio and kinetic data can be transferred between the gaming environment and the gamer. This provides input from the user, through motion of the headphone in to the gaming environment and from the gaming environment to the user through kinetic generators built into the headphone. Additionally, when the system is disconnected from the gaming environment and the microphone boom is in the retracted position, the user can use the headphones for a singular music listening experience. It will also be appreciated by one skilled in the art that the transceiver may be paired with a smart phone or table providing for use of the headphone in phone communication.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

Example embodiments are described herein in the context of an vehicle inventory and customer relation management systems and methods. Those of ordinary skill in the art will realize that the following description is illustrative only and is not intended to be in any way limiting. Other embodiments will readily suggest themselves to such skilled persons having the benefit of this disclosure. Reference will now be made in detail to implementations of the example embodiment as illustrated in the accompanying drawings. The same reference indicators will be used throughout the drawings and the following description to refer to the same or like items.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention. The present invention thus can be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes that come within the meaning and range of equivalency of the claims are to be embraced within their scope.

We claim:

1. A wireless audio headphone system comprising:
a curved semi-rigid band member for securing the system to the head of a user, the band member comprised of a first distal end for securing a first ear piece having a housing and second opposite distal end for securing a second ear piece having a housing;
an audio transducers disposed with each housing for generating audible sound;
an audio signal circuit in communication with each audio transducer and a microphone;
a power management circuit associated with a power source for providing and managing electric power to components of the system;
at least one first wireless audio transceiver disposed within at least one of the first ear piece housing or second ear piece housing and in communication with the audio circuit ;
a second wireless audio transceiver associated with a handheld gaming controller and in wireless communication with the at least one first audio transceiver, wherein the first and second wireless audio transceivers are configured to wirelessly communicate signals; and
a microphone boom member disposed within the first or second ear piece, the boom member configured to secure the microphone, the boom member associated with a boom release mechanism, the boom member having a deployed position wherein when the boom release mechanism is engaged, the boom extends from the housing, and the microphone is operational, the boom member having a retracted position wherein when the boom release mechanism is disengaged the boom is retracted into the housing, such that the boom is substantially flush with the housing, and the microphone is non-operational.

2. The system of claim 1 wherein the second wireless audio transceiver is disposed within a module capable of coupling to and communication with a gaming controller.

3. The system of claim 2 wherein the module is further comprised of controls for controlling functions of the system.

4. The system of claim 3 wherein the controls of the module control audio volume, balance or mute.

5. The system of claim 1 wherein the housing further comprises an electrical connector associated with the power management circuit for recharging the battery

7. The system of claim 1 wherein the boom release member includes a lock mechanism whereby the boom is locked into the deployed position or locked into the retracted position.

6. The system of claim 1 wherein the audio signal circuit is further comprised of a digital signal processor and communications are provided by digital communications.

7. The system of claim 1 wherein the digitally packaged signals are representative of audio and kinetic motion associated with a gaming environment.

8. The system of claim 1 further comprised of a kinetic force means wherein the kinetic force simulates action associated with the movement of a character in the gaming environment.

9. The system of claim 1 wherein the kinetic motion of the system directs the movement of a character in the gaming environment.

10. The system of claim 1 wherein the semi-rigid band member is configured to lengthen or shorten for securely conforming the system to the head of the user.
